(19) United States
(12) Patent Application Publication
(10) Pub. No.: US 2008/0224111 A1
(43) Pub. Date: Sep. 18, 2008

(54) CABLE HANDLING DEVICE

(75) Inventor: JOSEPH CHARLES URCIUOLI, NORTH EASTON, MA (US)

Correspondence Address: DYKAS, SHAVER & NIPPER, LLP, P.O. BOX 877, BOISE, ID, 83701-0877, US

(73) Assignee: MACTAGGART SCOTT (HOLDINGS) LIMITED, MIDLOTHIAN (GB)

(21) Appl. No.: 12/048,276

(22) Filed: Mar. 14, 2008

Related U.S. Application Data
(60) Provisional application No. 60/895,206, filed on Mar. 16, 2007.

(51) Int. Cl. B66D 1/00

(52) U.S. Cl. 254/266

(57) ABSTRACT

A cable handling device for use in the deployment and/or retrieval of a cable comprises a drum which provides mounting for a number of grooved rings, the rings receiving a cable thereabout. The drum forms an inner bearing race with each ring forming an outer bearing race such that the rings are independently and rotatably coupled to the drum. A second drum having one or more grooved ring is provided and the cable can be wound around the first and second drums. In use, one or both of the drums is rotated and the device is adapted to control the tension in the cable and/or to mitigate distortion in the cable caused by slippage between the cable and the device.

### CROSS-REFERENCE TO RELATED APPLICATIONS

This application claims the priority date of the provisional application entitled CABLE HANDLING DEVICE, filed on Mar. 16, 2007, with application Ser. No. 60/895,206, the disclosure of which is incorporated herein.

### FIELD OF THE INVENTION

The present invention relates to a cable handling device, and in particular, but not exclusively, to a capstan for use in a sea-going vessel.

### BACKGROUND TO THE INVENTION

Sea-going vessels such as ships, submarines or the like may be required to deploy and retrieve cables including, for example, but not exclusively, towed arrays, sonar equipment or the like. Deployment or retrieval of such cables may be facilitated by use of a capstan or similar device.

Referring to FIG. 1 of the drawings, a single drum capstan arrangement is shown, the capstan comprising a single capstan drum or spindle 10 around which a cable or rope 12 may be wrapped or wound. An alternative arrangement (not shown) provides a double drum capstan comprising two multi-groove drums, one drum having one less groove than the other. In use, a cable is adapted to be wound alternately around the first and second drums.

A capstan, whether comprising a single or double drum, may be utilised as a means of achieving a mechanical advantage in the addition or reduction of tension during deployment or retrieval of the cable. It will be recognised that the amount of tension that may be removed or added by wrapping around a capstan is a function of: the initial tension (T₁); the co-efficient of friction (μ) between the capstan and the cable; and the angle of contact (β radians) between the capstan and the cable. Thus, the tension may be ascertained from the capstan equation, T₂=T₁e^{μβ}.

For example, in the capstan arrangement shown schematically in FIG. 1, where the co-efficient of friction (μ) between the cable and capstan drum is 0.10, the tension ratio (T2\T1) of a single groove is approximately 1.369 for an angle of contact of approximately 180 degrees (3.14 radians). This is based on the assumption of infinite rigidity of the drum and cable. However, in reality, whereas drums tend to be relatively rigid, cables, ropes and, in particular, sensor arrays may not be.

It will be recognised that, when a capstan is engaged in retrieving a cable experiencing hydrodynamic drag, as the cable progresses from one groove to the next groove, the tension in the cable reduces. Thus, the cable will contract and its linear velocity will reduce. However, the surface velocity of the drum will remain constant. It is evident that where a difference in velocity is present, distortion between the capstan drum and the cable may arise. Therefore, relative elasticity between the drum and the cable may introduce relative velocities, or slippage, this slippage between the cable and drum resulting in frictional stresses which can be damaging to the cable.

Cable damage is of particular concern where it relates to an expensive and sophisticated cable such as a submarine or surface ship acoustic array and the distortion and/or damage to the cable caused by the relative velocity, or slippage, may result in the operational effectiveness of the vessel being compromised.

### SUMMARY OF INVENTION

According to a first aspect of the present invention, there is provided a cable handling device for use in the deployment or retrieval of a cable, the device comprising: a first driven member; a plurality of bearing members for receiving a cable thereabout, the bearing members being independently and rotatably coupled to the first driven member.

At least one of the bearing members may be adapted to slip relative to the first driven member. It will be recognised that slippage occurs, for example, where there is a relative velocity between the first driven member and the bearing member. Advantageously, relative velocity or slippage occurs between the first driven member and the bearing members as opposed to slippage between the cable and the bearing members.

A device according to embodiments of the present invention may be adapted to control the tension in a cable and/or to mitigate distortion in the cable caused by relative angular velocity or slippage between the device, for example, but not exclusively a capstan, and a cable or the like. Thus, frictional stresses between the device and the cable may be maintained within predetermined, and reduced, limits. The device may be utilised in the tensioning or de-tensioning of a cable wrapped or wound about the device, for example, but not exclusively, in the deployment or retrieval of a cable from a sea-going vessel, such as a submarine or the like.

It will be understood that the term cable applies to any elongate member, for example, but not exclusively, a cable, rope, wire, conduit or the like. In one embodiment of the present invention, the device is adapted for use in the deployment or retrieval of a cable array, such as may be utilised in a sea-going or submarine vessel's sensor array.

The bearing members may be configured for independent rotation with respect to each other. Each bearing member may be adapted to rotate at a different angular velocity relative to the first driven member and to at least one other bearing member, as required. Thus, each bearing member may slip relative to the first driven member independently. Advantageously, and as noted above, slippage may preferentially occur between the first driven member and each bearing member as opposed to slippage occurring between the respective bearing member and the cable.

Thus, tensioning or de-tensioning of the cable may be controlled in a quantifiable manner in which one or all of the bearing members may be employed or recruited to contribute to the tensioning or de-tensioning of the cable, where appropriate.

The bearing members may comprise discs or rings mounted around the first driven member. The bearing members and first driven member together may form or provide mounting for a bearing, for example, but not exclusively, a plain bearing, journal bearing or the like. The bearing members may be of different or varying diameters.

The bearing members may further comprise grooves or slots around their periphery for receiving at least a portion of the cable. Accordingly, the cable may be wound around the device such that a portion of the cable is received within the groove of the bearing member.

The first driven member may further comprise or provide mounting for a clutch plate or friction surface between the first driven member and each bearing member. Alternatively, or in addition, at least one of the bearing members may define or provide mounting for a clutch plate or friction surface. Accordingly, the degree of slippage occurring between the first driven member and the bearing members may be controlled within acceptable levels, each bearing member adapted to slip relative to the first driven member with each ring effectively finding the appropriate angular velocity for the relevant section of cable.

It will be recognised that the tensioning and de-tensioning ratio increases progressively according to the capstan equation for each driven ring. It will be further recognised that the maximum tensioning or de-tensioning ratio that can be provided by a 180° turn on a single ring is a function of the bearing friction value and the ratio of the radius ratio of the groove and bearing. Thus, by appropriate design of the bearing, through selection of the frictional co-efficient and radius ratio between the bearing and ring, the tension ratio can be set to a safe level where the risk of damage to the cable is minimised.

The device may further comprise a rotary drive. The rotary drive may comprise a motor, for example, but not exclusively, an electric motor, hydraulic motor or other suitable rotary drive.

The first driven member may comprise a drum, shaft, axle or the like. The first driven member may be integral to, or alternatively may be coupled to, the rotary drive.

In one embodiment, the device may further comprise a second driven member. The second driven member may comprise a drum, shaft, axle or the like.

The second driven member may provide support for at least one bearing member. The bearing members may comprise grooved rings, each groove adapted to receive a section of cable.

The second driven member may be rotatably coupled to the first driven member.

The second driven member may be synchronously rotatably coupled to the first driven member, for example, but not exclusively, through a chain, belt, gearing arrangement or the like.

Alternatively, the second driven member may be driven independently by a second rotary drive means. Alternatively, the second driven member may be idle with respect to the first driven member.

In one embodiment, the axis of rotation of the first driven member may be angled such that the cable is aligned with the corresponding next groove of the second driven member.

The device may further comprise a frame rotatably coupled to the first driven member, the frame adapted to support the first driven member. The first driven member may be adapted to rotate with respect to the frame. Where a second driven member is provided, the frame may also be adapted to support the second driven member.

### BRIEF DESCRIPTION OF THE DRAWINGS

These and other aspects of the present invention will now be described, by way of example only, with reference to the accompanying drawings, in which:

FIG. 1 is a schematic view of a single drum capstan;

FIG. 2 is a perspective view of a cable device according to an aspect of the present invention;

FIG. 3 is a sectional view of the cable device of FIG. 1;

FIG. 4 is a schematic view of the cable device of FIGS. 1 and 2 during deployment of a cable; and

FIG. 5 is a schematic view of the cable device of FIGS. 1 to 3 during retrieval of a cable.

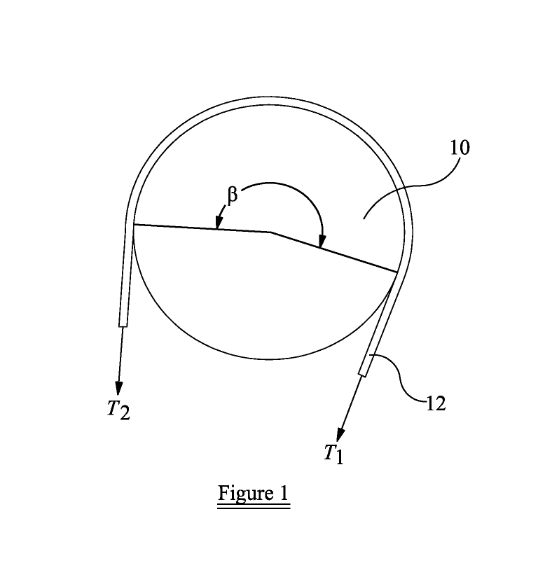

### DETAILED DESCRIPTION OF THE DRAWINGS

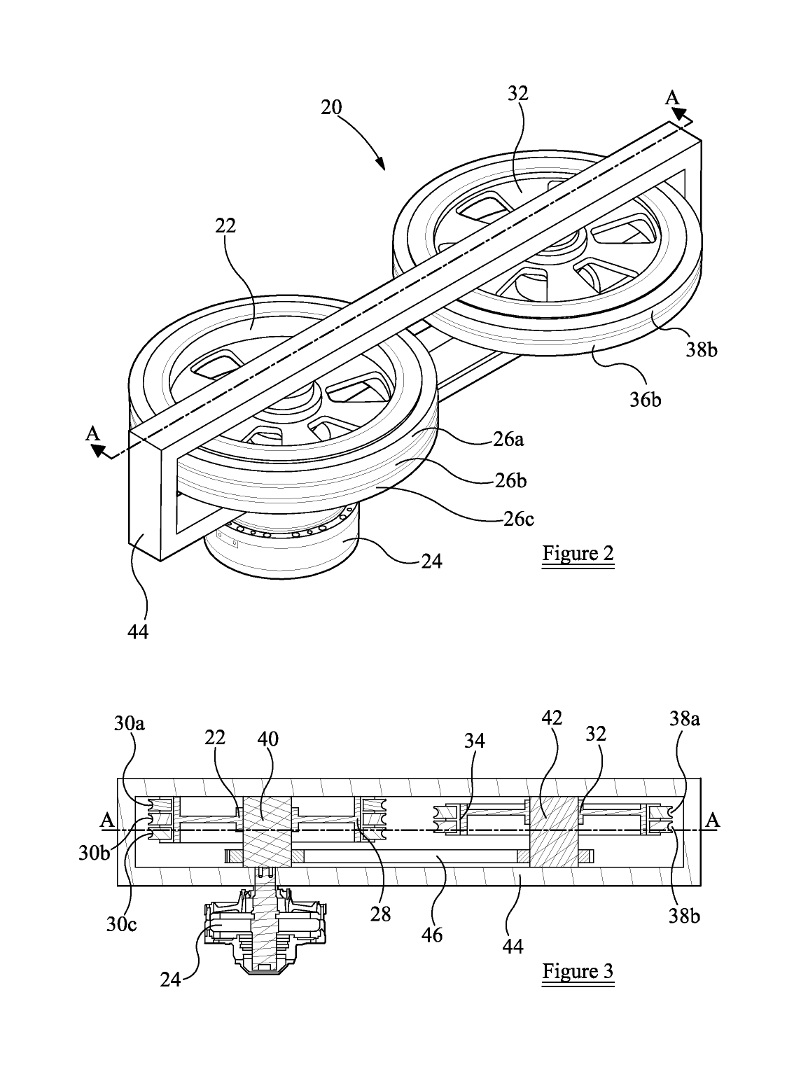

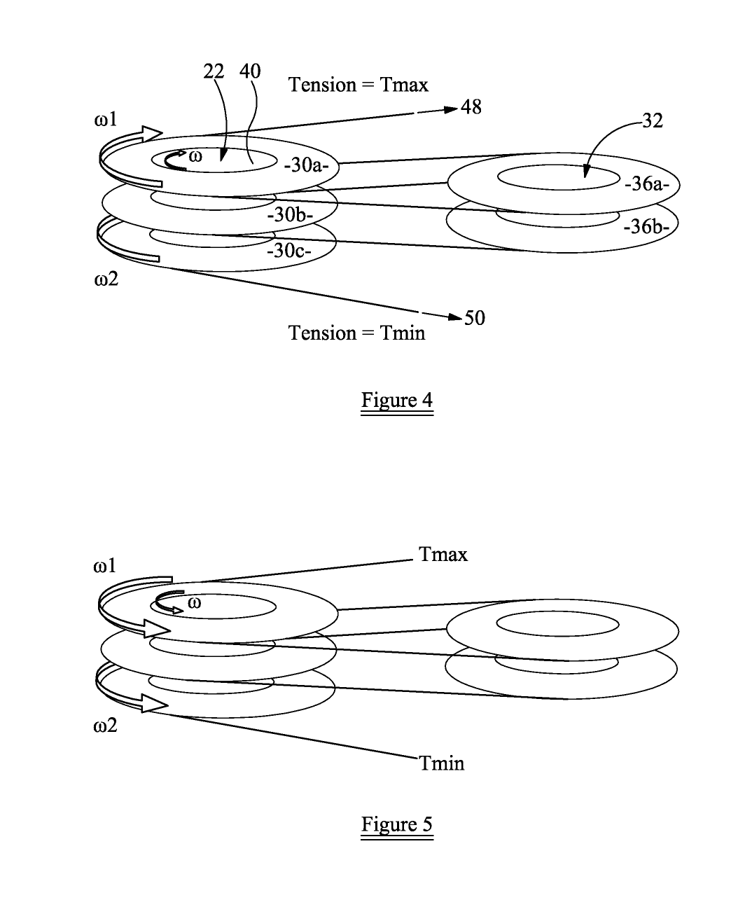

In reference initially to FIGS. 2 and 3 of the drawings, there is shown a perspective view of a cable handling device 20 in accordance with an embodiment of the present invention, the device 20 for use in the deployment or retrieval of a cable 12 (as shown in FIG. 4 or 5). The device 20 comprises a first drum 22 rotatably coupled to a drive motor 24, the drum 22 comprising the inner races of journal bearings 28a, 28b and 28c. As shown, the bearing races 28a, 28b and 28c are of the same diameter. However, it will be recognised that the bearing races 28a, 28b and 28c may be of varying diameters in order to achieve additional variations in the tensioning and de-tensioning capability of the device 20.

As shown in FIG. 2, three discs or rings 26a, 26b and 26c are coupled around the first drum 22, the rings 26a, 26b and 26c comprising the outer races of the journal bearings 28a, 28b and 28c (shown most clearly in FIG. 3). Although the rings 26a, 26b and 26c are shown as being of substantially equal diameter, the rings 26a, 26b and 26c may be different or varying diameter. Each ring 26a, 26b, 26c comprises a groove 30a, 30b, 30c extending around the circumference of the ring 26a, 26b, 26c and the grooves 30a, 30b, 30c are adapted to receive a section of cable 12 (as shown in FIGS. 4 and 5).

The device 20 further comprises a second drum 32 of similar construction to the first drum 22. The second drum 32 thus comprises the inner races of journal bearings 34a and 34b. It will again be recognised that the bearing races 34a, 34b may be of different or varying diameters in order to achieve additional variations in the tensioning and de-tensioning capability of the device 20. Two rings 36a and 36b rotationally mounted around the second drum 32 comprise the outer races of the bearings 34a and 34b. The rings 36a, 36b also comprise grooves 38a, 38b extending around the circumference of the rings 36a, 36b.

Each drum 22, 32 comprises a central hub or shaft portion 40, 42, the shafts 40, 42 mounted for rotation within a support frame 44.

The device 20 further comprises a synchronising drive in the form of a chain drive 46 (shown most clearly in FIG. 3) coupled between the first shaft 40 and the second shaft 42 and, in use, it will be recognised that rotation of the first shaft 40 by the motor 24 will result in synchronous rotation of the second shaft 42 via the chain 46.

Operation of the device 20 will now be described with reference to FIGS. 2 to 5 of the drawings. The cable 12 is wound around the grooves 30a, 30b, 30c, 38a, 38b of the first and second drums 22, 32 in accordance with the sequence 30a, 38a, 30b, 38b, 30c, the cable 12 being retained by frictional engagement with the grooves 30a, 30b, 30c 38a and 38b.

In reference particularly to FIG. 4 of the drawings, which schematically represents operation of the device 20 during deployment of the cable 12, the maximum tension in the cable 12 is maintained by an external force as shown by arrow 48, typically, hydrodynamic drag. The minimum tension in the cable 12 is maintained by a second external force as shown by arrow 50, this force exerted by a storage winch (not shown) typically used to store the cable 12.

During deployment of the cable 12, the drive motor 24 (as shown in FIGS. 2 and 3) is operated to rotate the first shaft 40 at a first angular velocity of ω radians per second. As the cable 12 is deploying, a retarding torque acts to oppose the direction of rotation. Thus, the cable 12 will tend to slip forward relative to the drum 22. It will be recognised that, as the rings 26a, 26b and 26c; and 36a and 36b are independently rotatable with respect to their respective drum 22, 32, the first ring 26a has an angular velocity of ω₁ radians per second, where ω₁ is greater than the shaft speed ω.

As the cable 12 around ring 26a is under higher tension than the other rings, slippage will be initiated at this ring 26a with rings 36a, 26b, 36b and 26c being recruited in sequence until the required de-tensioning ratio is achieved. Thus, the angular velocity ω₂ of final ring 26c is less than the angular velocity ω₁ of first ring 26a. Furthermore, the angular velocity ω₂ of final ring 26c is less than or equal to the angular velocity of the first shaft 40.

It will be understood that slippage occurs preferentially between the rings 26a, 26b, 26c, 36a, 36b and the respective drum 22, 32 rather than between the cable 12 and the grooves 30a, 30b, 30c 38a and 38b. This is the case, for example, where the following condition is met:

$${μ}_{bearing} < k \cdot \frac{{R}_{groove}}{{R}_{bearing}} \cdot {μ}_{groove} ,$$

where μ_{bearing} is the coefficient of friction in the bearing; μ_{groove} is the coefficient of friction in the groove; R_{groove} is the radius of the groove; R_{bearing} is the radius of bearing; and k is a factor that accounts for the pressure distribution between the cable and groove being different to the pressure distribution in the bearing.

As discussed hereinabove, the maximum de-tensioning ratio that can be provided by a 180 degree turn on a single groove can be shown to be a function of the bearing friction value and the ratio of the radius ratio of the groove and bearing. This can be expressed by the following:

$$\frac{{T}_{2}}{{T}_{1}} = \frac{1 + {μ}_{bearing} \cdot \frac{{R}_{bearing}}{{R}_{groove}}}{1 - {μ}_{bearing} \cdot \frac{{R}_{bearing}}{{R}_{groove}}}$$

or, where an ‘equivalent coefficient of friction (μ_{equiv}) is defined,

$$\frac{{T}_{2}}{{T}_{1}} = \frac{1 + {μ}_{equiv}}{1 - {μ}_{equiv}} , where {μ}_{equiv} = {μ}_{bearing} \cdot \frac{{R}_{bearing}}{{R}_{groove}}$$

Though not wishing to be bound by theory, it will be recognised that, through selection of the frictional coefficient and the ratio of the bearing and groove radii, the tension ratio may be controlled within a pre-selected level such that the risk of damage to the cable may be substantially eliminated or mitigated.

In reference now to FIG. 5 of the drawings, which schematically represents operation of the device 20 during retrieval of the cable 12, the drums 22, 32 are rotated in the opposite direction (as shown by the arrows in FIG. 5) to that for deployment of the cable 12 and at an angular velocity of ω radians per second. Thus, the forces are reversed such that slippage will be initiated at ring 26c with rings 36b, 26b, 36a and 26a being recruited in sequence until the required tensioning ratio is achieved.

Accordingly, by the provision of independently rotatable rings 26a, 26b, 26c, 36a, and 36b, the present invention may be utilised to set a predetermined, and reduced, limit to the frictional stress between the device 20 and the cable 12 such that the negative effects of distortion and/or slippage of the cable relative to the device 20 may be mitigated or substantially minimised.

Those of skill in the art will further recognise that the illustrated device is merely exemplary of the present invention, and that the same objectives may be achieved by using a variety of different configurations.

1. A cable handling device for use in the deployment or retrieval of a cable, the device comprising:
a first driven member; and
a plurality of bearing members for receiving a cable thereabout, the bearing members being independently and rotatably coupled to the first driven member.

2. The cable handling device of claim 1, wherein at least one of the bearing members is adapted to slip relative to the first driven member.

3. The cable handling device of claim 1, wherein at least one of the bearing members is configured for independent rotation with respect to at least one other bearing member.

4. The cable handling device of claim 1, wherein the bearing members comprise grooved rings mounted around the first driven member.

5. The cable handling device of claim 1, wherein one or more of the bearing members are of the same diameter.

6. The cable handling device of claim 1, wherein one or more of the bearing members are of different diameters.

7. The cable handling device of claim 1, wherein the first driven member or at least one of the bearing members further comprises or provides mounting for a clutch plate or friction surface.

8. The cable handling device of claim 1, further comprising a rotary drive.

9. The cable handling device of claim 1, wherein the first driven member is selected from one of, or a combination of, a drum, a shaft, and an axle.

10. The cable handling device of claim 8, wherein the first driven member is integral to the rotary drive.

11. The cable handling device of claim 8, wherein the first driven member is adapted to be coupled to the rotary drive.

12. The cable handling device of claim 1, further comprising a second driven member.

13. The cable handling device of claim 12, wherein the second driven member is selected from one of, or a combination of, a drum, a shaft and an axle.

14. The cable handling device of claim 12, wherein the second driven member provides support for at least one bearing member.

15. The cable handling device of claim 12, wherein the second driven member is adapted to be coupled to the first driven member.

16. The cable handling device of claim 15, wherein the second driven member is adapted to be synchronously rotatably coupled to the first driven member.

17. The cable handling device of claim 12, wherein the second driven member is adapted to be driven independently by a second rotary drive means.

18. The cable handling device of claim 12, wherein the second driven member is idle with respect to the first driven member.

19. The cable handling device of claim 12, wherein the axis of rotation of the first driven member is angled such that the cable is aligned with the corresponding next groove of the second driven member.
